(19) United States
(12) Patent Application Publication
(10) Pub. No.: US 2020/0103638 A1
(43) Pub. Date: Apr. 2, 2020

(54) ALL-REFLECTIVE DIP MICROSCOPE OBJECTIVE

(71) Applicant: UCHICAGO ARGONNE, LLC, Chicago, IL (US)

(72) Inventors: Michael J. Pellin, Naperville, IL (US); Robert G. Wagner, Bolingbrook, IL (US); Howard W. Nicholson, South Hadley, MA (US)

(73) Assignee: UCHICAGO ARGONNE, LLC, Chicago, IL (US)

(21) Appl. No.: 16/144,818

(22) Filed: Sep. 27, 2018

(51) Int. Cl. G02B 21/04; G02B 21/16; G02B 21/36

(52) U.S. Cl. CPC G02B 21/04; G02B 21/361; G02B 21/16

(57) ABSTRACT

An all-reflective objective includes a transparent substrate having a concave side and a convex side; a first reflective surface provided on the concave side of the transparent substrate; and a second reflective surface provided on the convex side of the transparent substrate. The first reflective surface comprises one of a mirror or a reflective coating. The second reflective surface comprises one of a mirror or a reflective coating.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### FIELD OF THE INVENTION

The present invention relates generally to the field of microscope objectives. In particular, the present invention relates to an all-reflective microscope objective amenable to dipping (use in high index refraction media).

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In an optical system, an objective is an optical element that includes one or more lenses or mirrors. The objective receives light from an object being observed, for example, by a microscope, camera, telescope, or other optical system, and focuses the light to produce an image. Objectives are characterized by several inter-related parameters including working distance, field of view, and resolution. Working distance refers to a distance from the objective's front lens or mirror to the closest surface of the object being observed when the object is sharply focused. Field of view refers to an area that can be seen. Resolution refers to a minimum distance between two objects that can be resolved. Light microscope objectives form the basis for many technologies including 3D printing, 2-photon fluorescence microscopy, confocal microscopy, etc.

The most commonly used category of objectives is refractive objectives. Light passing through the optical system is refracted, or bent, by the refractive objectives. The refractive objectives may include an anti-reflection coating that reduces back reflections and improve overall light throughput. Typically, refractive objectives are made of compound refractive lenses whose resolution depends on a solid angle of light collection and a refractive index of the working media (for example, typically n=−1.4 for oils, glasses). Thus, high resolution depends on large solid angles of collection and high indexes of refraction. This has disadvantages including the objective having narrow focal ranges, short working distances and small fields of view.

Another category of objectives is reflective objectives. An example of a reflective objective is a Schwarzschild objective, which includes a concave mirror having an opening in the center thereof and a convex mirror arranged coaxially with the concave mirror such that the convex mirror opposes the opening of the concave mirror. The Schwarzschild objective is also referred to as an all-reflecting objective. Since light is reflected by metallic surfaces and not refracted by glass surfaces, reflective objectives do not suffer from the same aberrations as refractive objectives. In particular, the concave mirror and the convex mirror are arranged to cross cancel aberrations and to focus light. Schwarzschild objectives have very large working distances and large fields of view for a given resolution. Schwarzschild objectives have not been widely used, however, because as opposed to refractive objectives, Schwarzschild objectives are not amenable to dipping (i.e., use in high index of refraction media). Schwarzschild objectives are not amenable to dipping in an immersion medium other than air because in a medium having a higher index of refraction than air, the light passing through the Schwarzschild objective suffers from considerable aberrations, thereby reducing the resolution at the object being view. As used herein, the term “dipping” is interchangeable with the term “immersion,” where both terms refer to the objective being dipped or immersed in a working fluid (e.g., a monomeric photoresist). Thus, Schwarzschild objectives cannot achieve the highest resolutions possible.

A need exists for improved technology, including technology that allows all-reflective microscope objectives to be used in high index refraction media.

### SUMMARY

One embodiment of the invention relates to an all-reflective objective comprising a transparent substrate having a concave side and a convex side; a first reflective surface provided on the concave side of the transparent substrate; and a second reflective surface provided on the convex side of the transparent substrate. The first reflective surface comprises one of a mirror or a reflective coating. The second reflective surface comprises one of a mirror or a reflective coating. In some aspects, the first reflective surface may comprise the mirror and the second reflective surface may comprise the reflective coating. In some aspects, the first reflective surface may comprise the reflective surface and the second reflective surface may comprise the mirror. In some aspects, the first reflective surface may comprise the mirror and the second reflective surface may comprise the mirror. In some aspects, the first reflective surface may comprise the reflective coating and the second reflective surface may comprise the reflective coating. In some aspects, at least one of the first reflective surface and the second reflective surface comprises the mirror and the reflective coating. In some aspects, both of the first reflective surface and the second reflective surface comprise the mirror and the reflective coating.

In some aspects, the first reflective surface may include an opening in a center thereof, and the first reflective surface may be in contact with the convex side of the transparent substrate such that the transparent substrate opposes the opening of the first reflective surface.

In some aspects, the second reflective surface may be in contact with the concave side of the transparent substrate.

In some aspects, the first reflective surface may include an opening in the center thereof; the second reflective surface may be arranged coaxially with the first reflective surface such that the second reflective surface opposes the opening of the first reflective surface; the first reflective surface may be in contact with the convex side of the transparent substrate such that the transparent substrate opposes the opening of the first reflective surface; and the second reflective surface may be in contact with the concave side of the transparent substrate.

In some aspects, an apparatus configured to produce a magnified image of an object includes a light source; the all-reflective objective of the preceding paragraph; and an immersion medium in which the object and the all-reflective objective are at least partially immersed such that the immersion medium entirely fills a space between the object and the all-reflective objective. The index of refraction of the immersion medium will be chosen to be similar to that of the transparent objective. In some aspects, an index of refraction of the immersion medium may be equal to or greater than 1.4.

In some aspects, a method of using the all-reflective objective to perform 3D printing, two-photon fluorescence microscopy, or confocal microscopy. The all-reflective objective comprises a transparent substrate having a concave side and a convex side; a first reflective surface provided on the concave side of the transparent substrate; and a second reflective surface provided on the convex side of the transparent substrate. The first reflective surface comprises one of a mirror or a reflective coating. The second reflective surface comprises one of a mirror or a reflective coating.

In some aspects, an apparatus configured to produce a 3D image of an object includes a light source; any of the all-reflective objectives described above; and a photosensitive material that reacts with light from the light source to produce the 3D image. The photosensitive material may react with light from the light source via two-photon polymerization.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The disclosure will become more fully understood from the following detailed description, taken in conjunction with the accompanying figures, in which:

FIG. 1 illustrates an objective including a concave mirror, a convex mirror and a transparent substrate there between.

FIG. 2A illustrates the objective of FIG. 1 where the concave mirror is replaced with a reflective coating.

FIG. 2B illustrates the objective of FIG. 1 where the convex mirror is replaced with a reflective coating.

FIG. 3 illustrates the objective of FIG. 1 where both the concave mirror and the convex mirror are replaced with a reflective coating.

FIG. 4 illustrates an optical system including an object, an objective, and a light source. The object and the transparent substrate are at least partially immersed in an immersion or dipping medium.

FIG. 5 illustrates an optical system including an object, an objective, and an immersion lens (e.g., a meniscus lens). The object and the transparent substrate are at least partially immersed in an immersion or dipping medium.

FIG. 6 illustrates an optical system including sample (object), an objective, and an immersion lens (e.g., a meniscus lens). FIG. 6 illustrates the three-dimensional nature of the objective.

FIG. 7 illustrates an optical system including an object, an objective, and an immersion lens (e.g., a meniscus lens). The objective includes a concave mirror with a reflective coating, and a convex mirror with a reflective coating. Here in order to allow light to enter into the immersion fluid, a transparent medium object is added to allow the light to penetrate the immersion fluid. The transparent medium object has an index of refraction similar to the immersion fluid. The transparent medium object should also have a surface structure on the objective or top side such that light entering the transparent medium object does not undergo total reflection.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

As used herein, the term “all-reflective microscope objective,” “all-reflective objective” or “reflective objective” refers to an objective that focuses light using mirrors (reflecting surfaces). In particular, unless otherwise indicated, the terms “all-reflective microscope objective,” “all-reflective objective,” and “reflective objective” are interchangeable, and may refer to an optical lens located nearest to the object to be viewed or in the case of photolithography, the object being printed, and which contains only reflecting elements/surfaces (i.e. mirrors), as opposed to refractive optical elements typically composing microscope objective lenses.

In general, the all-reflective objective described in the embodiments below includes a transparent substrate (e.g., a SiO₂ substrate) having a concave side and a convex side, a first reflective surface provided on the concave side of the transparent substrate, and a second reflective surface provided on the convex side of the transparent substrate. The first reflective surface may be a mirror, a reflective coating or a combination thereof. The second reflective surface may be a mirror, a reflective coating or a combination thereof. Specific embodiments of the all-reflective objective will be described below.

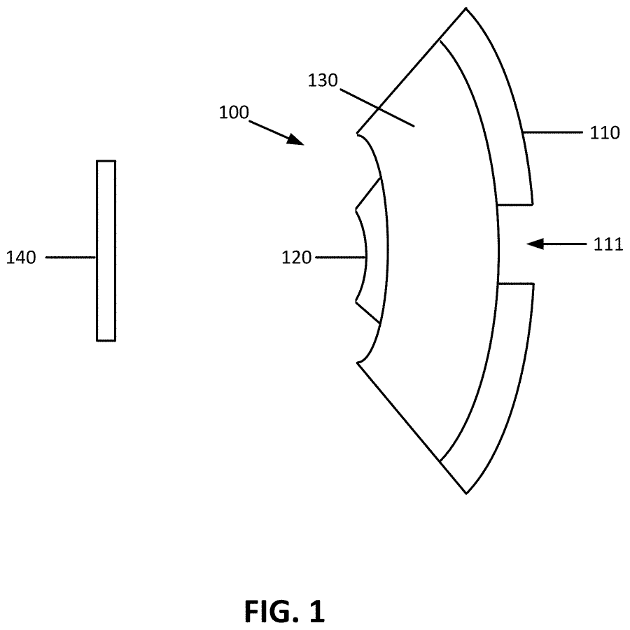

Referring to FIG. 1, in a first embodiment, an objective 100 used to view an object 140 is a modified Schwarzschild objective. Similar to the Schwarzschild objective, the objective 100 includes a concave mirror 110 having an opening 111 in the center thereof and a convex mirror 120 arranged coaxially with the concave mirror 110 such that the convex mirror 120 opposes the opening 111 of the concave mirror 110. In a conventional Schwarzschild objective, air is present between the concave mirror 110 and the convex mirror 120. The objective 100 differs from a conventional Schwarzschild objective in that the objective 100 further includes a transparent substrate 130 located between the concave mirror 110 and the convex mirror 120. The transparent substrate 130 may include naturally occurring silicon dioxide or synthetic silicon dioxide. Preferably, the transparent substrate 130 is natural quartz or fused quartz. The refractive index of the transparent substrate 130 is approximately 1.46. The refractive index of the transparent substrate 130 is higher than the refractive index of air. As a result, unlike a conventional Schwarzschild objective, the objective 100 is amenable to dipping/immersion. As seen in FIG. 1, the transparent substrate 130 has a concave side and a convex side such that the surfaces of the transparent substrate 130 conform to the shape of the concave mirror 110 and the convex mirror 120. The concave mirror 110, the transparent substrate 130 and the convex mirror 120 form a continuous structure. The transparent substrate 130 completely fills the space between the concave mirror 110 and the convex mirror 120. Preferably, the concave mirror 110, the transparent substrate 130 and the convex mirror 120 have the same index of refraction throughout so as to avoid dispersion of the light source (e.g., laser beam). The dimensions of the objective 100 are determined by the known equations which define a Schwarzschild objective. These equations require that the concave mirror and the convex mirror have a specific radius of curvature ratio, that their centers are collocated and that the object be located at a certain (large) working distance from the concave and convex mirrors.

In operation, light entering the opening 111 reflects off a first reflective surface (the convex mirror 120) and travels to a second reflective surface (the concave mirror 110) where it is reflected and focused to the object 140. Alternatively, light entering the opening 111 travels the opposite path from the object 140 back out through the opening 111. In either case, the convex mirror 120 does not extend across the entire convex arc of the transparent substrate 130, as it would block the path of the light totally. Therefore, the convex mirror 120 needs to be smaller than the convex arc of the convex arc of the transparent substrate 130 to allow light to pass.

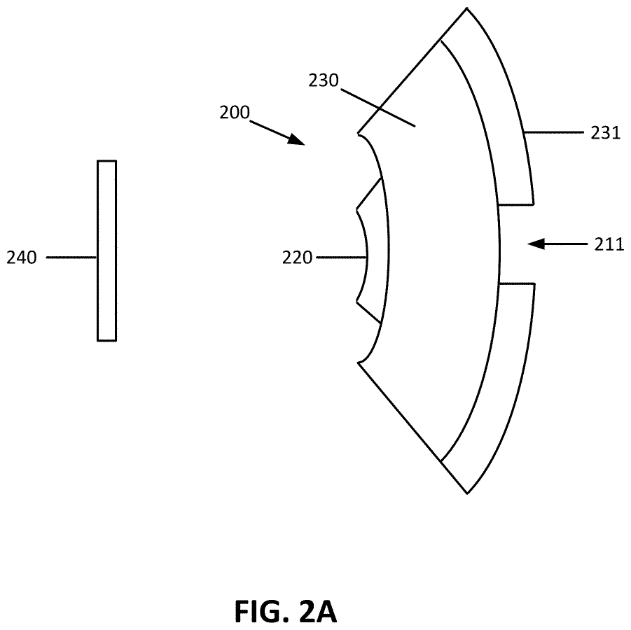

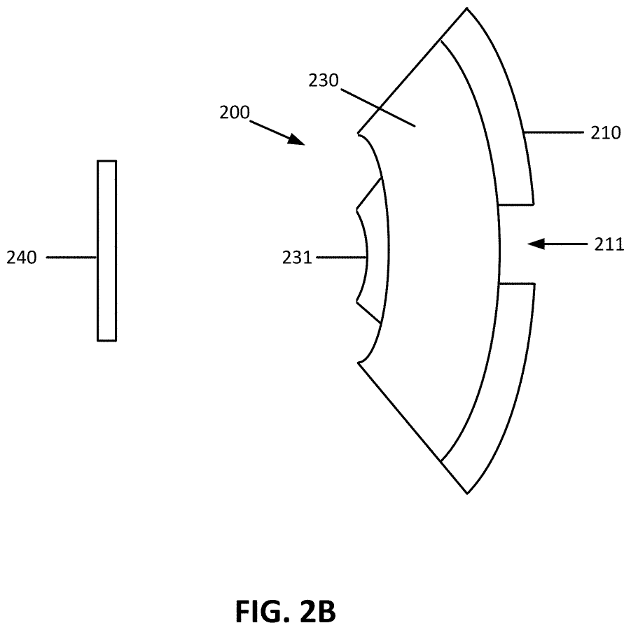

Referring to FIGS. 2A-2B, an objective 200 for viewing an object 240 is similar to the objective 100, except that one of the concave mirror 110 and the convex mirror 120 of FIG. 1 is replaced with a reflective coating 231. In some examples, as illustrated in FIG. 2A, the objective 200 includes a convex mirror 220, a transparent substrate 230, and a reflective coating 231. The reflective coating 231 of FIG. 2A is a concave coating (i.e., provided on the side on which the concave mirror 110 of FIG. 1 was provided). The concave reflective coating 231 includes an opening 211 in the center thereof that corresponds to the opening 111 of FIG. 1. In other examples, as illustrated in FIG. 2B, the objective 200 includes a concave mirror 210, a transparent substrate 230, and a reflective coating 231. The reflective coating 231 of FIG. 2B is a convex coating (i.e., provided on the side on which the convex coating mirror 120 of FIG. 1 was provided).

In operation, light entering the opening 211 of a first reflective surface (either in the concave mirror 210 of FIG. 2B or the concave reflective coating 231 of FIG. 2A) reflects off the second reflective surface (either the convex mirror 220 of FIG. 2A or the convex reflective coating 231 of FIG. 2B) and travels to the first reflective surface where it is reflected and focused to the object 240. Alternatively, light entering the opening 211 travels the opposite path from the object 240 back out through the opening 211. In either case, the second reflective surface does not extend across the entire convex arc of the transparent substrate 230, as it would block the path of the light totally. Therefore, the second reflective surface needs to be smaller than the convex arc of the convex arc of the transparent substrate 230 to allow light to pass.

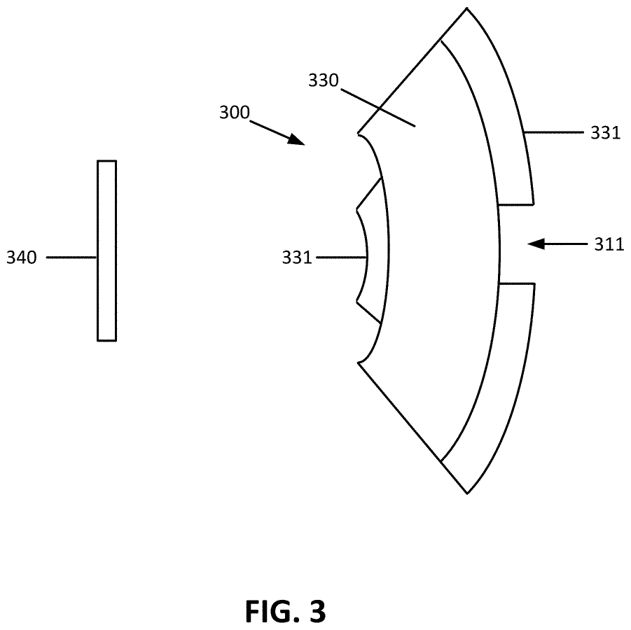

Referring to FIG. 3, an objective 300 used to view an object 340 is similar to the objective 100 of FIG. 1, except that both the concave mirror 110 and the convex mirror 120 of FIG. 1 have been replaced by a reflective coating 331. The objective 300 includes a concave reflective coating 331, a transparent substrate 330, and a convex reflective coating 331. The concave reflective coating 331 includes an opening 311 in the center thereof that corresponds to the opening 111 of FIG. 1. In additional examples (not illustrated) the reflective coating 331 may be provided on an entire outer periphery (i.e., all sides) of the transparent substrate 330.

In operation, light entering the opening 311 of a first reflective surface (the concave reflective coating 331) reflects off a second reflective surface (the convex reflective surface 331) and travels to the first reflective surface where it is reflected and focused to the object 340. Alternatively, light entering the opening 311 travels the opposite path from the object 340 back out through the opening 311. In either case, the second reflective surface does not extend across the entire convex arc of the transparent substrate 330, as it would block the path of the light totally. Therefore, the second reflective surface needs to be smaller than the convex arc of the convex arc of the transparent substrate 330 to allow light to pass.

In any of the embodiments described above, the reflective coating on the transparent substrate may be made of any material with a high reflection coefficient for the light to be used. While any reflectance will produce a focused spot, as the reflectance drops the input light is lost (by the product of the reflectances). As used herein, a high reflection coefficient refers to a coefficient that allows for greater than or equal to 80% reflectance, for example, greater than or equal to 85% reflectance. This may require a different reflective coating material to be used for ultraviolet light usage (single photon stereolithography) than the reflective coating material used for infrared light usage (two photon polymerization lithography). The reflective coating may be, for example, a metallic coating such as an aluminum coating or a silver coating. In other examples, the reflective coating may be a deep UV (DUV) enhanced aluminum coating, which allows reflection down to a wavelength of about 135 nm, or a gold coating, which is useful for infrared above 800 nm. DUV enhanced aluminum is particular useful for covering the wavelength range used for example, in two photon polymerization applications. In even further examples, the reflective coating may be a dielectric multilayer coating.

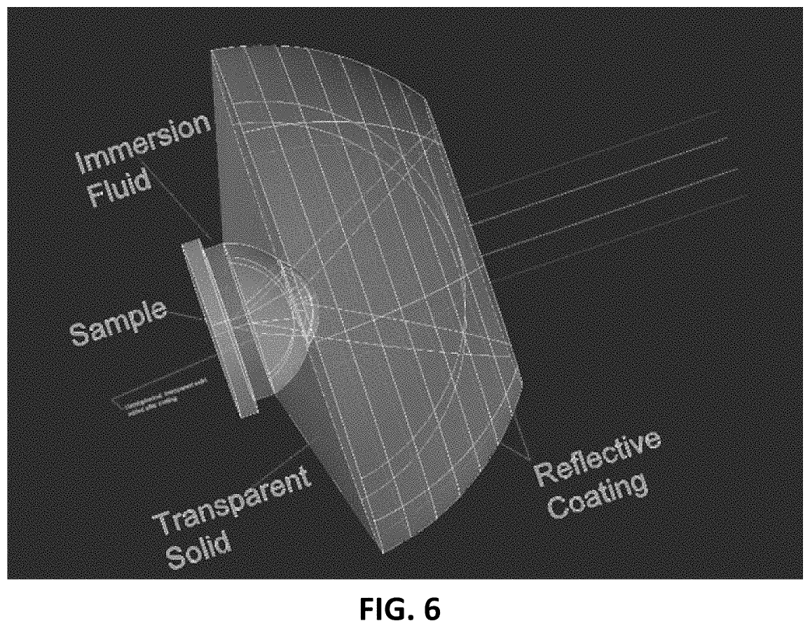

The objectives 100, 200, and 300 are all-reflecting objectives. Provision of the transparent substrate 130, 230, 330 with the reflective surfaces (i.e., two mirrors, two reflective coatings, or one mirror plus one reflective coating) enlarges the field of view by a factor of 100 when compared to conventional objectives. The reflective surface arrangement imparts a much larger field of view. In addition, provision of the transparent substrate or other transparent solid (see FIG. 6) allows the objective to be immersed without an index of refraction change (i.e., the transparent substrate keeps the index of refraction constant throughout the objective and removes the aberration that would happen if the light exits the objective into air and then enters the photoresist). Thus, light rays exit the all-reflecting objective and enter the immersion medium without deflection. This reduces the spot size by a factor of the refractive index of the objective. This same factor would have otherwise reduced the field of view. The objective 100, 200, 300 allows for the use of a wide range of object and image positions without significant degradation in resolution. For example, significant degradation in resolution may refer to degradation of the resolution from 100-200 nm (achieved by the embodiments described herein) to 500 nm. In the applications described below, structures may be printed, for example, with a precision of 1 micron. Thus, 500 nm resolution is a significant degradation that would tend to blur these structures. In most cases, the actual spot size will be determined by the wavelength of the light and the change with object and image positions will leave this spot size unchanged. If the object size is large (such that the spot size is determined by this size), then the change may reach 1-10%.

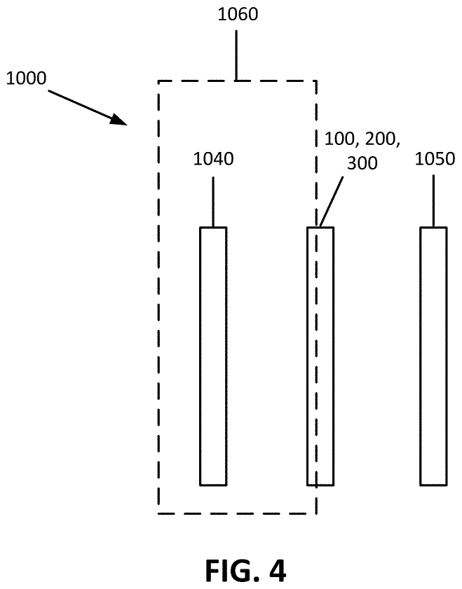

Referring to FIG. 4, an optical system 1000 used to view an object 1040 includes a light source 1050 and any of the objectives 100, 200, 300. The optical system 1000 may optionally include an immersion or dipping medium 1060 in which the object 1040 and the objective 100, 200, 300 are at least partially immersed. A distance between mirrors or reflective coatings provided on opposite sides of the transparent substrate may be on the order of millimeters such that only the surface on the reflective surface on convex side of the transparent substrate, or the reflective surface on the convex side of the transparent substrate and a portion of the transparent substrate are dipped in the dipping medium. In another example, the object 1040 and the objective 100, 200, 300 may be partially immersed in the immersion or dipping medium 1060 provided that a space between the object 1040 and the objective 100, 200, 300 is filled with the immersion or dipping medium 1060. The immersion or dipping medium 1060 may be, for example, oil, water or any other liquid medium with a high index of refraction. A “high index of refraction” may be, for example, an index of refraction approximately 1.4 or greater. Provision of the immersion or dipping medium 1060 increases the numerical aperture of the objective 100, 200, 300. If the space between the object and the objective is filled with an immersion or dipping medium having a refractive index n, then the wavelength in the immersion or dipping medium is

$${λ}_{n} = \frac{λ}{n} \qquad ( Eq . 1 )$$

The numerical aperture NA, which is a measure of an optical system's ability to collect light and resolve fine specimen (object) detail at a fixed object distance, is calculated as follows:

NA=n sin α (Eq. 2)

where the angle α is one-half the angular aperture of the objective. The resolution of the optical system (smallest resolvable d) is calculated as follows:

$${d}_{m i n} = 2 \frac{λ}{NA}$$

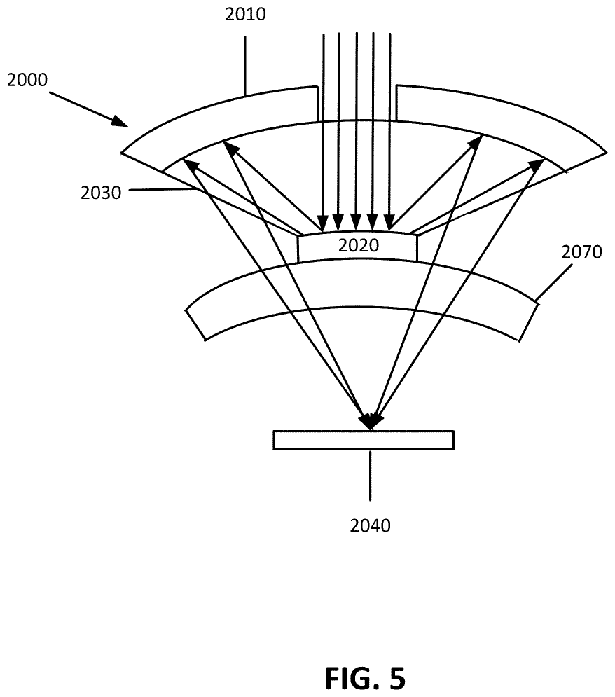

Referring to FIG. 5, an optical system 2000 used to view an object 2040 includes an objective having an concave mirror 2010 having an opening 2011 in the center thereof; a convex mirror 2020 arranged coaxially with the concave mirror 2010 such that the convex mirror 2020 opposes the opening 2011 of the concave mirror 2010; and a transparent substrate 2030 located between the concave mirror 2010 and the convex mirror 2020. The transparent substrate 2030 may have a reflective coating (not illustrated) on at least one of the concave or convex side thereof. The optical system 2000 further includes an immersion lens 2070 (e.g., a meniscus lens) positioned below the convex mirror 2020. Although the objective is all-reflecting, the immersion lens 2070 is a refractive element such that the optical system 2000 as a whole is not all-reflective.

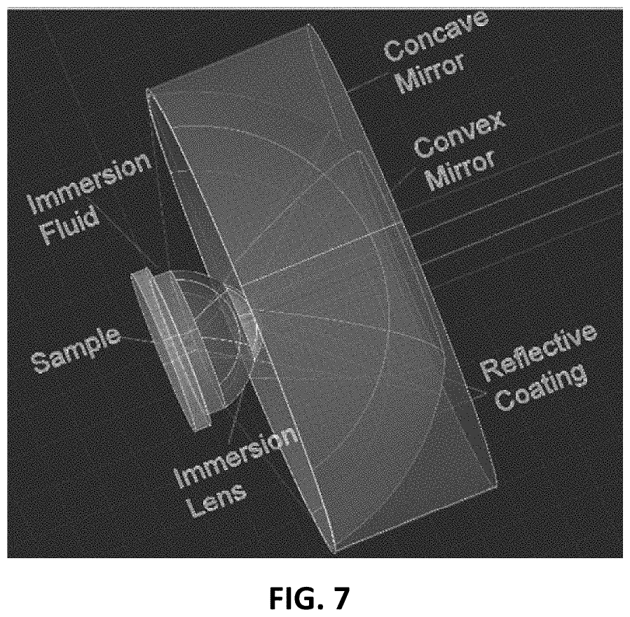

In some examples, the immersion lens 2070 may contact the convex mirror 2020 such that there is no air gap between the immersion lens 2070 and the convex mirror 2020 (see FIG. 7). In other examples, the immersion lens 2070 does not have to contact the convex mirror 2020, provided a gap between the immersion lens 2070 and the convex mirror 2020 is filled with dipping medium or photoresist. In some examples, the immersion lens 2070 may have a higher index of refraction than the transparent substrate and the dipping medium or photoresist such that the immersion lens 2070 provides additional focusing. The immersion lens 2070 may have a lens shape on both the side thereof where the light enters (concave mirror side) and the side thereof where light exits. However, since the immersion lens 2070 is immersed, its shape on the sample side is not relevant (it has no effect on the light rays), and thereof, in some examples, the immersion lens 2070 may not have a lens shape on the sample side. Due to the curvature of the immersion lens 2070, light rays from the concave mirror 2010 are always perpendicular to both surfaces of the immersion lens 2070. The concave mirror 2010, the transparent substrate 2030 and the convex mirror 2020 are continuous such that the volume between the mirrors has approximately the same index of refraction as the immersion or dipping medium 2060.

The objective 100, 200, 300 may be used in any application that includes light microscope objectives. For example, the objective 100, 200, 300 may be used in 3D printing, two-photon fluorescence microscopy, confocal microscopy, etc. The objectives 100, 200, 300 may replace the microscope lens pair in any two-confocal microscopy set up.

3D Printing

The objective 100, 200, 300 may be used in any know 3D printing process. For example, stereolithography and digital laser projection (DLP) create 3D objects using a pool of photoreactive resin. In stereolithography, the objective 100, 200, 300 in combination with one or more lenses may be used to focus a laser beam into a concentrated point that cures the photoreactive resin on contact. In DLP, the objective 100, 200, 300 in combination with one or more lenses may be used to project a laser beam in a desired shape of layer such that all areas of a layer of the 3D object are cured at once. These steps are repeated layer by layer until the desired 3D object is printed.

In laser sintering, the objective 100, 200, 300 in combination with one or more lenses may be used to focus a laser beam over a bed of superfine powder, fusing the particles together to form a thin, solidified layer. More powder is swept over the top of the layer, and the process is repeated until the desired 3D object is printed.

In polyjet 3D printing, droplets of photo-reactive resin are dropped onto a build surface, and then immediately cured with ultraviolet light. The objective 100, 200, 300 in combination with one or more lenses may be used to focus the ultraviolet light. These steps are repeated layer by layer until the desired 3D object is printed. With the objective 100, 200, 300, it is possible to work in the ultra-violet (UV) or infrared (IR) spectral regions due to the use of mirrors compared to conventional refractive objectives.

When 3D printing with conventional objectives, a translation stage must be used to move the growing 3D object to an optimum focal position. This translation must be done with high resolution, even for very large parts, and often is the limiting factor in print time. In 3D printing, there is an object (usually formed at the focus of a lens in front of the laser) and then an image. The distance to each are related by the magnification. Thus, by moving the object location, the image location moves, thereby moving the spot where the printing occurs. In contrast, use of the objective 100, 200, 300 only requires moving the lens that forms the object location. In other words, it is not necessary to move the microscope objective or the 3D object being formed. The objective 100, 200 enlarges the field of view by a factor of 100 as compared to conventional objective. This results in up to a 10,000× reduction in printing time, as the precision needed is reduced by the magnification. In some cases, the motion precision required is reduced by up to 100×. In fact, because the magnification is over constrained, changes in position up to 4 mm do not significantly affect the resolution of the printed part. When printing, for example, microchannel plates, channel plates having a diameter on the order of meters may be printed in the same amount of time it takes to print channel plates having a diameter on the order of centimeters using a conventional objective. Microchannel plates produced using the objective 100, 200 exhibit higher gain (×10), higher counting rates (10) and higher spatial resolution (1 μm pores have been built) all at a 100-1000× reduction in cost. Use of the objective 100, 200 also allows for printing a 3D object having a greater range of dimensions.

Two-Photon Photoresist

Another method of producing a 3D object is two-photon polymerization with ultrashort laser pulses. The objective 100, 200, 300 in combination with one or more lenses may be used to focus the laser pulses into a volume of a photosensitive material or photoresist, thereby initiating two-photon polymerization. In particular, desired structures are illuminated in the photosensitive material or photoresist and the non-illuminated regions are washed out. The polymerized material maintains the desired 3D shape.

Two photon fluorescent microscopy develops a three-dimensional picture of a sample by scanning a laser through the microscope similar to the process of 3D printing. In particular, in two photon fluorescent microscopy, photoresists are UV polymerized to create a 3D printed structure. Photoresists can also be polymerized using infrared light of twice the wavelength (half the energy) of the UV light when two photons are simultaneously absorbed, thereby providing the necessary energy to polymerize the photoresists. UV light entering the photoresist will cause polymerization along the entire path length of the light since all photons have the required energy to cause polymerization. In two photon polymerization, the probability of simultaneous absorption of two IR photons is only significant in the small volume defined by the focus of the laser beam, i.e. approximately a spherical volume of radius 50-100 nm. Thus, polymerization of the resist only occurs in this volume providing the much finer resolution of printing. The intensity of the fluorescence is recorded as a laser is scanned across the volume (X, Y, & Z). Two photon fluorescent microscopy is a powerful imaging technique used often in biology, but the process is relatively slow and limited by the field of view. Use of the objective described in the examples herein would improve two photon fluorescent microscopy with the improved field of view.

Confocal Microscopy

Confocal microscopy, most frequently confocal laser scanning microscopy, is an optical imaging technique for increasing optical resolution and contrast of a micrograph by using a spatial pinhole to block out-of-focus light in image formation. Capturing multiple two-dimensional images at different depths in a sample enables the reconstruction of three-dimensional structures within an object. This technique is used extensively in the scientific and industrial communities and typical applications are in life sciences, semiconductor inspection and materials science. Use of the objective described in the examples herein would provide large fields of view, while maintaining high resolution, thereby allowing for a more rapid analysis of large volumes.

The construction and arrangements of the objective, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, image processing and segmentation algorithms, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Embodiments of the subject matter and the operations described in this specification (for example, 3D printing) can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

What is claimed:

1. An all-reflective objective comprising:
a transparent substrate having a concave side and a convex side;
a first reflective surface provided on the concave side of the transparent substrate; and
a second reflective surface provided on the convex side of the transparent substrate,
wherein the first reflective surface comprises one of a mirror or a reflective coating, and
wherein the second reflective surface comprises one of a mirror or a reflective coating.

2. The all-reflective objective of claim 1, wherein the first reflective surface comprises the mirror and the second reflective surface comprises the reflective coating.

3. The all-reflective objective of claim 1, wherein the first reflective surface comprises the reflective coating and the second reflective surface comprises the mirror.

4. The all-reflective objective of claim 1, wherein the first reflective surface comprises the mirror and the second reflective surface comprises the mirror.

5. The all-reflective objective of claim 1, wherein the first reflective surface comprises the reflective coating and the second reflective surface comprises the reflective coating.

6. The all-reflective objective of claim 1, wherein:
the first reflective surface includes an opening in a center thereof, and
the first reflective surface is in contact with the convex side of the transparent substrate such that the transparent substrate opposes the opening of the first reflective surface.

7. The all-reflective objective of claim 1, wherein the second reflective surface is in contact with the concave side of the transparent substrate.

8. The all-reflective objective of claim 1, wherein:
the first reflective surface has an opening in the center thereof;
the second reflective surface is arranged coaxially with the first reflective surface such that the second reflective surface opposes the opening of the first reflective surface,
wherein the first reflective surface is in contact with the convex side of the transparent substrate such that the transparent substrate opposes the opening of the first reflective surface, and
wherein the second reflective surface is in contact with the concave side of the transparent substrate.

9. The all-reflective objective of claim 1, wherein the transparent substrate is a SiO₂ substrate.

10. An apparatus configured to produce a magnified image of an object, the apparatus comprising:
a light source;
an all-reflective objective comprising
a transparent substrate having a concave side and a convex side;
a first reflective surface provided on the concave side of the transparent substrate; and
a second reflective surface provided on the convex side of the transparent substrate; and
an immersion medium in which the object and the all-reflective objective are at least partially immersed such that the immersion medium entirely fills a space between the object and the all-reflective objective,
wherein the first reflective surface comprises one of a mirror or a reflective coating, and
wherein the second reflective surface comprises one of a mirror or a reflective coating.

11. The apparatus of claim 10, wherein an index of refraction of the immersion medium is equal to or greater than 1.4.

12. The apparatus of claim 10, wherein the first reflective surface comprises the mirror and the second reflective surface comprises the reflective coating.

13. The apparatus of claim 10, wherein the first reflective surface comprises the reflective coating and the second reflective surface comprises the mirror.

14. The apparatus of claim 10, wherein the first reflective surface comprises the mirror and the second reflective surface comprises the mirror.

15. The apparatus of claim 10, wherein the first reflective surface comprises the reflective coating and the second reflective surface comprises the reflective coating.

16. An apparatus configured to produce a 3D image of an object, the apparatus comprising:
a light source;
an all-reflective objective comprising
a transparent substrate having a concave side and a convex side;
a first reflective surface provided on the concave side of the transparent substrate; and
a second reflective surface provided on the convex side of the transparent substrate; and
a photosensitive material that reacts with light from the light source to produce the 3D image,
wherein the first reflective surface comprises one of a mirror or a reflective coating, and
wherein the second reflective surface comprises one of a mirror or a reflective coating.

17. The apparatus of claim 16, wherein the photosensitive material reacts with light from the light source via two-photon polymerization.

18. A method of using the all-reflective objective of claim 1 to perform 3D printing, two-photon fluorescence microscopy, or confocal microscopy.
